(19) United States
(12) Patent Application Publication
(10) Pub. No.: US 2026/0351630 A1
(43) Pub. Date: Nov. 5, 2026

(54) METAL SEPARATOR AND METHOD FOR MANUFACTURING SAME

(71) Applicant: Hyundai Steel Company, Incheon (KR)

(72) Inventors: Dae Hong Ha, Incheon (KR); Jae Ho Lee, Incheon (KR); Won Seog Yang, Incheon (KR); Ju Hyun Yoo, Incheon (KR)

(21) Appl. No.: 19/489,544

(22) PCT Filed: Nov. 13, 2024
(86) PCT No.: PCT/KR2024/096507

§ 371 Date: Dec. 2, 2025

(30) Foreign Application Priority Data
Nov. 21, 2023 (KR) 10-2023-0162726

(51) Int. Cl. H01M 8/0228; H01M 8/021; H01M 8/0213; H01M 8/0226

(52) U.S. Cl. CPC H01M 8/0228; H01M 8/021; H01M 8/0213; H01M 8/0226

(57) ABSTRACT

The present application relates to a metal separator and a method for manufacturing same. According to the metal separator and the manufacturing method therefor of the present application, electrical conductivity and corrosion resistance can be excellent at the same time.

### TECHNICAL FIELD

The present application relates to a metal separator and a method for manufacturing the same.

### BACKGROUND ART

Recently, in order to address global warming, powertrains technology is shifting from internal combustion engines (ICEs) to electric vehicles (EVs) or hydrogen fuel cell electric vehicles (FCEVs). Fuel cells used in FCEVs are used to supply driving power for industrial, household, and vehicular applications as well as power for small electronic products such as portable devices, and their use is gradually expanding as a highly efficient and clean energy source in terms of both energy conservation and environmental protection.

A fuel cell is a type of power generation device that converts chemical energy of fuel into electrical energy through an electrochemical reaction within a stack, and generates power by utilizing the energy generated during the combination reaction of hydrogen and oxygen. Specifically, the fuel cell may use hydrogen gas as fuel, and generate protons and electrons through an oxidation reaction of hydrogen gas. The protons and electrons generated at this time undergo an electrochemical reaction with oxygen in the air to produce water, while also generating electrical energy from the flow of electrons.

Such a hydrogen fuel cell is composed of a separator, a gas diffusion layer (GDL), and a membrane electrode assembly coated with catalyst powder. The hydrogen fuel cell can theoretically generate a voltage of 1.229 V, but has an operating voltage of 0.6 V to 0.8 V due to various limitations such as inherent characteristics of the above components and characteristics between the components.

Among these components, the separator is a key component that separates and distributes hydrogen and oxygen within the hydrogen fuel cell, respectively, and transmits the current generated by the electrochemical reaction.

As the separator, a metal separator based on materials such as stainless steel or titanium is mainly used. The stainless steel- or titanium-based separators generally have high conductivity, but have the disadvantage of being easily corroded in high temperature, high humidity and/or acidic environments within the stack. As corrosion progresses, oxides are formed on the corroded surface. The metal oxides act as insulators to reduce the electrical conductivity of the metal separator, thereby reducing the performance of the hydrogen fuel cell.

Coating is required to prevent corrosion that causes performance degradation of the metal separator. Such a coating should not lower the conductivity of the metal separator and should be able to increase the corrosion resistance of the metal separator. In addition, in a coating, it is difficult to expect a single material to have high conductivity while also being chemically stable and having high corrosion resistance. Accordingly, there is a need for a metal separator that can simultaneously secure high conductivity and corrosion resistance by separately coating a material responsible for corrosion resistance and a material responsible for conductivity on the metal separator material, and a method for manufacturing the same.

### DISCLOSURE

### Technical Problem

An object of the present application is to provide a metal separator having excellent electrical conductivity and corrosion resistance at the same time, and a method for manufacturing the same.

### Technical Solution

In order to achieve the above object, a metal separator of the present application comprises: a metal substrate; and a coating layer formed on the surface of the metal substrate and including a conductive filler and an inorganic polymer, wherein the conductive filler is included in the coating layer at an area ratio of 5% to 95%.

The conductive filler may include at least one selected from carbon black, carbon nanotubes, graphene, and carbon fibers.

In addition, the conductive filler may have a particle diameter of 10 nm to 100 nm.

In addition, the inorganic polymer may be a polymer containing a bond between a Group IVB transition metal element and an oxygen atom.

In addition, the metal substrate may be a substrate made of titanium or stainless steel.

In addition, the coating layer may have a thickness of 10 nm to 100 nm.

In addition, the coating layer may have a contact resistance of 1 mΩ·cm² to 20 mΩ·cm².

In addition, the coating layer may have a current density of 0.5 μA/cm² to 30 μA/cm².

In addition, the present application relates to a method for manufacturing a metal separator, wherein the metal separator comprises a metal substrate; and a coating layer formed on the surface of the metal substrate and including a conductive filler and an inorganic polymer, wherein the conductive filler is included in the coating layer at an area ratio of 5% to 95%, the method comprising: a first coating step of coating a coating mixture containing a conductive filler and water on the surface of a metal substrate, followed by drying to form a coating layer; and a second coating step of coating a liquid metal-based organic substance on the dried coating layer, followed by heat treatment to gel the liquid metal-based organic substance into an inorganic polymer.

In addition, the conductive filler may be included in the coating mixture in an amount of 0.3 to 5 parts by weight per 100 parts by weight of water.

In addition, the drying may be performed at a temperature of 100 °C or more and less than 400 °C under an air atmosphere for 30 seconds to 10 minutes.

In addition, the liquid metal-based organic substance may exist in a state in which the metal-based organic substance represented by Chemical Formula 1 below is dispersed in a liquid dispersion medium:

M(OR)₄ [Chemical Formula 1]
wherein Mis a Group IVB transition metal element, and R is a straight or branched alkyl group having 1 to 6 carbon atoms.

In addition, the coating of the liquid metal-based organic substance on the dried coating layer may be performed by immersing the metal substrate having the dried coating layer formed thereon in the liquid metal-based organic substance, such that the liquid metal-based organic substance is incorporated into the region of the coating layer from which the water has been removed.

In addition, the heat treatment may be performed through one or more steps selected from a first heat treatment step performed at a temperature of 100 °C to 380 °C under an air atmosphere; and a second heat treatment step performed at a temperature of 450 °C to 600 °C under a vacuum atmosphere.

### Advantageous Effects

According to the metal separator and the manufacturing method therefor of the present application, both electrical conductivity and corrosion resistance can be excellent at the same time.

### DESCRIPTION OF DRAWINGS

FIG. 1 is a diagram exemplarily illustrating a metal separator according to one embodiment of the present application.

FIG. 2 is a diagram exemplarily illustrating a metal separator obtained by coating a coating mixture on the surface of a metal substrate and then drying it, for explaining a first coating step according to one embodiment of the present application.

FIG. 3 is a diagram exemplarily illustrating a metal substrate having an oxide film formed on the surface thereof before pickling treatment, for explaining a pickling treatment according to one embodiment of the present application.

FIG. 4 is a diagram exemplarily illustrating a metal substrate in which an oxide film on the surface has been removed after pickling treatment, for explaining a pickling treatment according to one embodiment of the present application.

FIG. 5 is a 1,000× magnification image obtained by photographing the surface of a metal separator subjected to a first coating step in Example 1 with a scanning electron microscope.

FIG. 6 is a 20,000× magnification image obtained by photographing the surface of a metal separator subjected to a first coating step in Example 1 with a scanning electron microscope.

FIG. 7 is a 50,000× magnification image obtained by photographing the surface of a metal separator subjected to a first coating step in Example 1 with a scanning electron microscope.

FIG. 8 is a 50,000× magnification image obtained by photographing the surface of a metal separator subjected to a second coating step in Example 1 with a scanning electron microscope.

### BEST MODES OF THE INVENTION

Hereinafter, a metal separator of the present application will be described with reference to the attached drawings, wherein the attached drawings are exemplary, and the metal separator of the present application is not limited to the attached drawings.

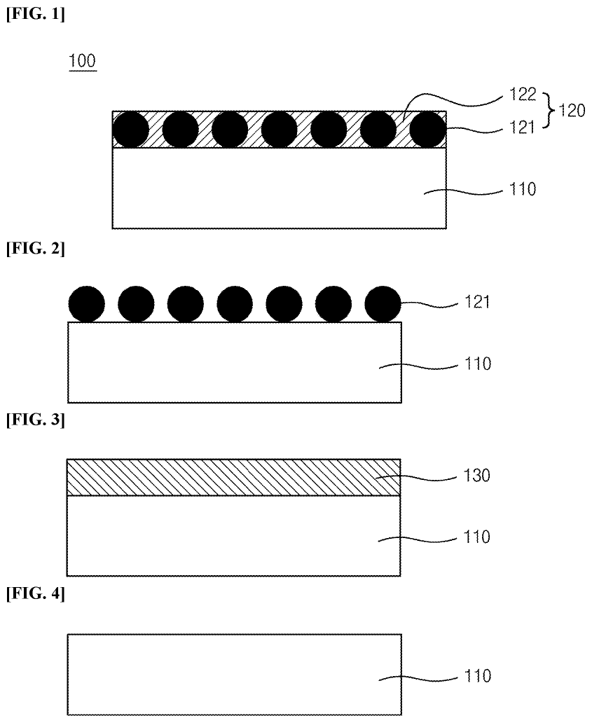

FIG. 1 is a diagram exemplarily illustrating a metal separator according to one embodiment of the present application. As shown in FIG. 1, the metal separator 100 of the present application includes a metal substrate 110 and a coating layer 120. According to the metal separator 100 of the present application, both electrical conductivity and corrosion resistance can be excellent at the same time.

The metal substrate 110 is a metal material used in a metal separator for a fuel cell. There is no particular limitation on the type of the metal substrate 110, and any metal substrate used in a metal separator for a fuel cell may be used without limitation. For example, a substrate made of titanium or stainless steel may be used as the metal substrate 110. Specifically, stainless steel such as SUS 316L, SUS 443CT, or SUS 470FC may be used as the metal substrate 110. The metal separator 100 can have excellent electrical conductivity by including the above-described metal substrate 110.

The coating layer 120 is a layer coated on the surface of the metal substrate 110, and is formed on the surface of the metal substrate 110 and includes a conductive filler 121 and an inorganic polymer 122. The coating layer 120 is formed on the surface of the metal substrate 110, whereby not only the electrical conductivity but also the corrosion resistance of the metal substrate 110 can be improved at the same time. In this specification, the term “surface” means an outer surface located on one side, both sides, or all sides of the metal substrate.

The conductive filler 121 is a material having electrical conductivity. For example, the conductive filler 121 may include at least one selected from carbon black, carbon nanotubes, graphene, and carbon fibers. In one embodiment, the conductive filler 121 may be carbon black. By including the conductive filler 121 in the coating layer 120, the electrical conductivity of the metal separator 100 can be improved.

In one example, the conductive filler 121 may have a particle diameter of 10 nm to 100 nm. Specifically, the particle diameter of the conductive filler 121 may have a lower limit of 20 nm or more, 30 nm or more, 40 nm or more, or 50 nm or more, and an upper limit of 90 nm or less, or 80 nm or less. The conductive filler 121 can improve electrical conductivity by having the above-described particle diameter.

In addition, the conductive filler 121 may be included in the coating layer 120 at an area ratio of 5% to 95%. Specifically, the conductive filler 121 may be included in the coating layer 120 at an area ratio of 5% to 95%, 10% to 95%, 15% to 95%, 20% to 95%, or 25% to 95%. Here, the area ratio of the conductive filler 121 may be measured on an image obtained by photographing the surface of the coating layer 120 formed on the metal separator 100 with a scanning electron microscope. The conductive filler 121 can improve electrical conductivity by being included in the coating layer 120 at the above-mentioned area ratio. In contrast, when the conductive filler 121 is included in the coating layer 120 in an area ratio less than the above-described area ratio, it may not be sufficient to secure electrical conductivity. In addition, when the conductive filler 121 is included in the coating layer 120 in an area ratio exceeding the above-described area ratio, the amount of highly corrosion-resistant material, specifically, inorganic polymer 122 formed on the surface of the metal substrate 110 is not sufficient, so it may not be easy to secure adhesion between the conductive filler 121 and the metal substrate 110.

The inorganic polymer 122 is a polymer with a backbone made of an inorganic substance other than carbon, and is a highly corrosion-resistant substance. For example, the inorganic polymer 122 may be a polymer containing a bond between a Group IVB transition metal element and an oxygen atom. Specifically, the Group IVB transition metal element may be a titanium (Ti) element, a zirconium (Zr) element, a hafnium (Hf) element, or a rutherfordium (Rf) element. That is, the inorganic polymer 122 may be a titanium sol-gel, a zirconium sol-gel, a hafnium sol-gel, or a rutherfordium sol-gel. By including the inorganic polymer 122 in the coating layer 120, the corrosion resistance of the metal separator 100 can be improved.

In one example, the coating layer 120 may have a thickness of 10 nm to 100 nm. Specifically, the thickness of the coating layer 120 may have a lower limit of 20 nm or more, 30 nm or more, 40 nm or more, or 50 nm or more, and an upper limit of 90 nm or less, or 80 nm or less. The coating layer 120 can be stabilized without loss of electrical conductivity by having the thickness range described above. The thickness of the coating layer 120 refers to a length from the lower surface to the upper surface of the coating layer 120 in contact with the metal substrate 110, and specifically, may refer to a thickness of a layer formed by an inorganic polymer 122, which is a corrosion-resistant substance.

In another example, the thickness of the coating layer 120, specifically the thickness of the layer formed by the inorganic polymer 122, may be equal to the particle diameter of the conductive filler 121 or greater than the particle diameter of the conductive filler 121 by 50 nm or less. When the thickness of the coating layer 120 is equal to the particle diameter of the conductive filler 121 or greater than the particle diameter of the conductive filler 121 by the range described above, it can be stabilized without loss of electrical conductivity. In contrast, when the thickness of the coating layer 120 is smaller than the particle diameter of the conductive filler 121, adhesion of the coating layer 120 cannot be secured, and coating of the inorganic polymer 122, which is a corrosion-resistant substance, may be difficult. In addition, when the thickness of the coating layer 120 is greater than the particle diameter of the conductive filler 121 by an amount exceeding the aforementioned range, it may be impossible to secure conductivity by covering all of the conductive filler 121.

The coating layer 120 may have a contact resistance of 1 mΩ·cm² to 20 mΩ·cm². Specifically, the contact resistance of the coating layer 120 may have an upper limit of 18 mΩ·cm² or less, or 15 mΩ·cm² or less. The coating layer 120 can allow the metal separator 100 to have excellent electrical conductivity by having the above-described contact resistance.

In addition, the coating layer 120 may have a current density of 0.5 μA/cm² to 30 μA/cm². Specifically, the current density of the coating layer 120 may be 0.6 μA/cm² to 20 μA/cm², 0.7 μA/cm² to 10 μA/cm², or 0.8 μA/cm² to 5 μA/cm². The coating layer 120 can allow the metal separator 100 to have excellent corrosion resistance by having the above-described current density.

The present application also relates to a method for manufacturing a metal separator. The method for manufacturing a metal separator relates to a method for manufacturing the above-described metal separator, and specific details regarding the metal separator to be described below may be the same as those described for the metal separator above, and thus will be omitted.

The method for manufacturing a metal separator of the present application includes a first coating step and a second coating step. According to the method for manufacturing a metal separator of the present application, both electrical conductivity and corrosion resistance can be excellent at the same time.

FIG. 2 is a diagram exemplarily illustrating a metal separator obtained by coating a coating mixture on the surface of a metal substrate and then drying it, for explaining a first coating step according to one embodiment of the present application. As shown in FIG. 2, the first coating step is a step of forming a conductive filler 121 on the surface of a metal substrate 110, and is performed by coating a coating mixture of the conductive filler 121 and water on the surface of the metal substrate 110 and then drying it. The method for manufacturing the metal separator can improve the electrical conductivity of the metal separator by including the first coating step.

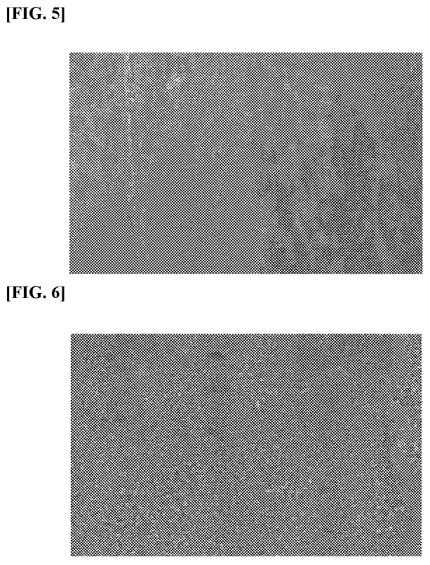

In one example, the method for manufacturing the metal separator may further include performing a pickling treatment before performing the first coating step. FIG. 3 is a diagram exemplarily illustrating a metal substrate having an oxide film formed on the surface thereof before pickling treatment, for explaining a pickling treatment according to one embodiment of the present application. FIG. 4 is a diagram exemplarily illustrating a metal substrate in which an oxide film on the surface has been removed after pickling treatment, for explaining a pickling treatment according to one embodiment of the present application. As shown in FIG. 3, the metal substrate 110 has an oxide film 130 naturally formed on the surface thereof. Since the oxide film 130 acts as an insulator, it may reduce the electrical conductivity of the metal separator, thereby reducing the performance of the hydrogen fuel cell. Therefore, the oxide film 130 formed on the surface of the metal substrate 110 may be removed by pickling treatment. Accordingly, as shown in FIG. 4, the first coating step may be performed on the metal substrate 110 having no oxide film 130 present on the surface thereof. For example, the pickling treatment may be performed with one or more selected from hydrogen fluoride, ammonium fluoride, hydrochloric acid, sulfuric acid, and acetic acid. The method for manufacturing the metal separator can further improve the electrical conductivity of the metal separator by further including pickling treatment before performing the first coating step.

In the first coating step, any coating method known in the art may be used without limitation as a coating method for the coating mixture, and for example, bar coating, spray coating, roll coating, dip coating, blade coating, brush coating, or the like may be used.

In addition, when the coating mixture is coated, the coating thickness may be 10 nm to 100 nm. Specifically, when the coating mixture is coated, the coating thickness may have a lower limit of 20 nm or more, 30 nm or more, 40 nm or more, or 50 nm or more, and an upper limit of 90 nm or less, or 80 nm or less. When the coating mixture is coated, the electrical conductivity of the metal separator can be improved by having the coating thickness within the above-mentioned range.

In the first coating step, the conductive filler may be mixed with the water and exist in a dispersed state within the water. The conductive filler may be included in the coating mixture in an amount of 0.3 to 5 parts by weight per 100 parts by weight of the water. Specifically, the conductive filler may be included in the coating mixture in an amount of 0.35 to 3 parts by weight per 100 parts by weight of the water. The conductive filler can improve the electrical conductivity of the metal separator by being included in the coating mixture in the above-described amount.

The drying is performed to remove water contained in the coating mixture, and may be performed, for example, at a temperature of 100 °C to 300 °C or 100 °C to 200 °C under an air atmosphere for 1 minute to 10 minutes, 5 minutes to 10 minutes, or 8 minutes to 10 minutes. When the drying is performed at a temperature lower than the above-mentioned temperature, the coating mixture may not be sufficiently dried. In addition, when the drying is performed at a temperature higher than the above-mentioned temperature, the conductive filler included in the coating mixture may be burned. Therefore, the drying may be performed under the above-mentioned temperature and time conditions.

As shown in FIG. 1, the second coating step is a step of forming an inorganic polymer 122 between the conductive fillers 121 formed on the surface of the metal substrate 110, and is performed by coating a liquid metal-based organic substance (not shown) on the coating layer dried in the first coating step, and then performing heat treatment to gel the liquid metal-based organic substance into an inorganic polymer. The method for manufacturing the metal separator can further improve corrosion resistance of the metal separator with improved electrical conductivity by including the second coating step.

The liquid metal-based organic substance may exist in a state in which the metal-based organic substance represented by Chemical Formula 1 below is dispersed in a liquid dispersion medium:

M(OR)₄ [Chemical Formula 1]
wherein M is a Group IVB transition metal element, and R is a straight or branched alkyl group having 1 to 6 carbon atoms.

Specifically, the Group IVB transition metal element may be a titanium (Ti) element, a zirconium (Zr) element, a hafnium (Hf) element, or a rutherfordium (Rf) element. By including the aforementioned Group IVB transition metal element in the liquid metal-based organic substance, the electrical conductivity of the metal separator 100 can be excellent.

In addition, the R may be a straight or branched alkyl group having 1 to 6 carbon atoms, and specifically, may be a straight or branched alkyl group having 1 to 5 carbon atoms, 1 to 4 carbon atoms, or 1 to 3 carbon atoms. Specific examples of the R include a straight alkyl group composed of ethyl, methyl, propyl, butyl, pentyl, or hexyl, or a branched alkyl group composed of n-propyl, isopropyl, n-butyl, isobutyl, sec-butyl, tert-butyl, 1-methyl-butyl, 1-ethyl-butyl, n-pentyl, isopentyl, neopentyl, tert-pentyl, n-hexyl, 1-methylpentyl, 2-methylpentyl, or 4-methyl-2-pentyl.

For example, the metal-based organic substance represented by Chemical Formula 1 above may be titanium tetraisopropoxide (Ti(OCH(CH₃)₂)₄), zirconium tetraisopropoxide (Zr(OCH(CH₃)₂)₄), titanium tetraethoxide (Ti(OC₂H₅)₄), or zirconium tetraethoxide (Zr(OC₂H₅)₄).

In another example, the metal-based organic substance may be charged with an inorganic acid. For example, the inorganic acid may be nitric acid (HNO₃), sulfuric acid (H₂SO₄), hydrochloric acid (HCl), phosphoric acid (H₃PO₄), perchloric acid (HClO₄), hypochlorous acid (HClO), hydrofluoric acid (HF), acetic acid (CH₃ COOH), or the like. By charging the metal-based organic substance with the above-mentioned inorganic acid, the metal contained in the metal-based organic substance can be stabilized.

As for the type of the dispersion medium, any dispersion medium known in the art may be used without particular limitation. By dispersing the metal-based organic substance represented by Chemical Formula 1 above in the liquid dispersion medium, an inorganic oligomer can be formed.

The concentration of the liquid metal-based organic substance may be 0.05 mol to 1 mol. The liquid metal-based organic substance can improve the corrosion resistance of the metal separator by having the above-mentioned concentration range.

In one example, the coating of the liquid metal-based organic substance on the dried coating layer may be performed by immersing the metal substrate having the dried coating layer formed thereon in the liquid metal-based organic substance, such that the liquid metal-based organic substance is incorporated into the region of the coating layer from which the water has been removed. Here, the immersion may be performed for 1 second to 10 minutes. Specifically, the immersion may be performed for 1 second to 8 minutes, or 1 second to 5 minutes. By performing the immersion for the above-mentioned time, the liquid metal-based organic substance can be incorporated into all areas of the coating layer from which the water has been removed.

In addition, the heat treatment may be performed through one or more steps selected from a first heat treatment step and a second heat treatment step. In one embodiment, in the heat treatment, both the first heat treatment step and the second heat treatment step are performed. For example, the first heat treatment step may be performed at a temperature of 100 °C to 380 °C for 30 seconds to 40 minutes under an air atmosphere. Specifically, the first heat treatment step may be performed at a temperature of 150 °C to 380 °C, 200 °C to 380 °C, 250 °C to 380 °C, 300 °C to 380 °C, or 350 °C to 380 °C under an air atmosphere for 1 minute to 30 minutes or 5 minutes to 20 minutes. In addition, the second heat treatment step may be performed at a temperature of 450 °C to 600 °C under a vacuum atmosphere for 10 to 60 minutes. Specifically, the second heat treatment step may be performed at a temperature of 450 °C to 550 °C or 450 °C to 500 °C under a vacuum atmosphere for 10 to 40 minutes or 10 to 20 minutes. By performing the heat treatment under the conditions described above, the liquid metal-based organic substance incorporated in the region of the coating layer from which the water has been removed can be gelled into the inorganic polymer 122. In this specification, the term “air atmosphere” means a working environment having an atmospheric state. In this specification, the term “vacuum atmosphere” means a working environment having a vacuum state. For example, the pressure of the vacuum atmosphere may be 0.0001 Pa to 0.01 Pa. By performing the heat treatment in each of the aforementioned atmospheres, the liquid metal-based organic substance can be gelled into the inorganic polymer 122, and the lattice of the titanium dioxide oxide film that may be generated during the gelling process can be distorted to improve electrical conductivity.

Hereinafter, the present application will be described in more detail through examples according to the present application and comparative examples not according to the present application, but the scope of the present application is not limited by the examples presented below.

### Example 1

### Manufacturing of Metal Separator

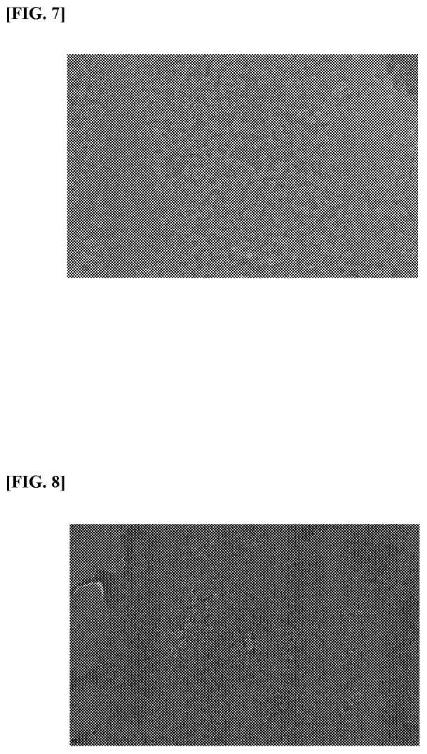

A titanium metal substrate (Grade 1) was prepared, and a coating mixture containing 0.96 wt % of carbon black as a conductive filler with a particle diameter of 50 nm and 99.04 wt % of water was bar-coated onto the surface of the titanium metal substrate, thereby forming a coating layer having an area ratio of 50% of the conductive filler and a thickness of 60 nm. Thereafter, the metal substrate coated with the coating mixture was dried at a temperature of 100 °C under an air atmosphere for 10 minutes to form a coating layer made of the conductive filler on the surface of the metal substrate. The surface of the metal substrate on which the dried coating layer was formed was photographed using a scanning electron microscope, and the results were shown in FIGS. 5 to 7. As shown in FIGS. 5 to 7, it was confirmed that the coating layer formed on the surface of the metal substrate had an area ratio of 50% of the conductive filler.

Thereafter, the metal substrate on which the dried coating layer was formed was bar-coated with a liquid metal-based organic substance having a concentration of 0.1 mol by dispersing titanium tetraisopropoxide (TTIP) in a dispersion medium, whereby the liquid metal-based organic substance was incorporated into the area from which the water was removed. Thereafter, the metal substrate having the coating layer into which the liquid metal-based organic substance had been incorporated was heat-treated at 380 °C under an air atmosphere for 10 minutes, and then heat-treated at 450 °C under a vacuum atmosphere of 0.01 Pa for 10 minutes, so that the liquid metal-based organic substance was gelled into a titanium sol-gel, which is an inorganic polymer, thereby manufacturing a metal separator having a coating layer with a thickness of 60 nm formed on the surface. The coating layer formed on the surface of the metal substrate of the metal separator was photographed, and the results were shown in FIG. 8. As shown in FIG. 8, it was confirmed that the coating layer formed on the surface of the metal substrate had an area ratio of 50% of the conductive filler.

### Example 2

### Manufacturing of Metal Separator

A titanium metal substrate (Grade 1) was prepared, and a metal separator was manufactured in the same manner as in Example 1, except that the surface of the titanium metal substrate was bar-coated with a coating mixture containing 0.38 wt % of carbon black as a conductive filler with a particle diameter of 50 nm and 99.62 wt % of water, thereby forming a coating layer having an area ratio of 25% of the conductive filler and a thickness of 60 nm on the surface of the titanium metal substrate.

### Example 3

### Manufacturing of Metal Separator

A titanium metal substrate (Grade 1) was prepared, and a metal separator was manufactured in the same manner as in Example 1, except that the surface of the titanium metal substrate was bar-coated with a coating mixture containing 1.54 wt % of carbon black as a conductive filler with a particle diameter of 50 nm and 98.46 wt % of water, thereby forming a coating layer having an area ratio of 70% of the conductive filler and a thickness of 80 nm on the surface of the titanium metal substrate.

### Comparative Example 1

### Manufacturing of Metal Separator

A titanium metal substrate (Grade 1) was prepared, and the surface of the titanium metal substrate was bar-coated with a coating mixture containing 0.96 wt % of carbon black as a conductive filler with a particle diameter of 50 nm and 99.04 wt % of water, thereby forming a coating layer having an area ratio of 50% of the conductive filler and a thickness of 60 nm. Thereafter, the metal substrate coated with the coating mixture was dried at a temperature of 100 °C under an air atmosphere for 10 minutes to form a coating layer, thereby manufacturing a metal separator.

### Comparative Example 2

### Manufacturing of Metal Separator

A titanium metal substrate (Grade 1) was prepared, and a metal separator was manufactured in the same manner as in Example 1, except that the surface of the titanium metal substrate was bar-coated with a coating mixture containing 0.24 wt % of carbon black as a conductive filler with a particle diameter of 50 nm and 99.76 wt % of water, thereby forming a coating layer having an area ratio of 3% of the conductive filler and a thickness of 40 nm on the surface of the titanium metal substrate.

### Comparative Example 3

### Manufacturing of Metal Separator

A titanium metal substrate (Grade 1) was prepared, and a metal separator was manufactured in the same manner as in Example 1, except that the surface of the titanium metal substrate was bar-coated with a coating mixture containing 30 wt % of carbon black as a conductive filler with a particle diameter of 50 nm and 70 wt % of water, thereby forming a coating layer having an area ratio of 100% of the conductive filler and a thickness of 200 nm on the surface of the titanium metal substrate.

### Comparative Example 4

### Manufacturing of Metal Separator

A metal separator made of titanium metal substrate (Grade 1) was prepared without forming a coating layer on the surface.

### Comparative Example 5

### Manufacturing of Metal Separator

A titanium metal substrate (Grade 1) was prepared, and the surface of the titanium metal substrate was bar-coated with a liquid metal-based organic substance having a concentration of 0.1 mol by dispersing titanium tetraisopropoxide (TTIP) in a dispersion medium, thereby coating the liquid metal-based organic substance on the surface of the metal substrate. Thereafter, the metal substrate coated with the liquid metal-based organic substance was heat-treated at 380 °C under an air atmosphere for 10 minutes, and then heat-treated at 450 °C under a vacuum atmosphere of 0.01 Pa for 10 minutes, so that the liquid metal-based organic substance was gelled into a titanium sol-gel, which is an inorganic polymer, thereby manufacturing a metal separator having a coating layer with a thickness of 50 nm formed on the surface.

### Experimental Example 1. Evaluation of Contact Resistance

For each of the metal separators manufactured in the examples and comparative examples, the contact resistance was measured by the IM6 equipment of Zahner using a four-wire current-voltage measurement principle, and the results were shown in Table 1 below. Specifically, the contact resistance measurement method was performed in a constant current mode in the range of from 10 kHz to 10 mHz with a DC current of 5 A, an amplitude of 0.5 A, and an electrode area of 25 cm² in the measurement region.

### Experimental Example 2. Evaluation of Current Density

The current density for each of the metal separators manufactured in the examples and comparative examples was measured using EG&G 273A measuring equipment under a simulated environment of a polymer electrolyte fuel cell (PEFC), and the results were shown in Table 1 below. Specifically, the current density was measured in the range of −0.25 V_{SCE} to 1.2 V_{SCE} of an open circuit potential (OCP) after placing each of the metal separators manufactured in the examples and comparative examples in a solution of 0.1 N H₂SO₄+2 ppm HF at 80 °C and bubbling with nitrogen (N₂) for 1 hour.

TABLE 1

| | Contact resistance | Current density |
|---|---|---|
| | (mΩ · cm²) | (μA/cm²) |
| Example 1 | 15 | 0.8 |
| Example 2 | 20 | 0.8 |
| Example 3 | 14 | 2.6 |
| Comparative Example 1 | 8 | 70 |
| Comparative Example 2 | 14 | 70 |
| Comparative Example 3 | 8 | 70 |
| Comparative Example 4 | 17 | 70 |
| Comparative Example 5 | 257 | 0.8 |

As shown in Table 1 above, it was confirmed that each of the metal separators manufactured in Examples 1 to 3 had low contact resistance and current density simultaneously, unlike each of the metal separators manufactured in Comparative Examples 1 to 5, and thus both electrical conductivity and corrosion resistance were excellent simultaneously.

### DESCRIPTION OF REFERENCE NUMERALS

100: Metal separator
110: Metal substrate
120: Coating layer
121: Conductive filler
122: Inorganic polymer
130: Oxide film

1. A metal separator comprising:
a metal substrate; and
a coating layer formed on the surface of the metal substrate and including a conductive filler and an inorganic polymer,
wherein the conductive filler is included in the coating layer at an area ratio of 5% to 95%.

2. The metal separator of claim 1, wherein the conductive filler includes at least one selected from carbon black, carbon nanotubes, graphene, and carbon fibers.

3. The metal separator of claim 1, wherein the conductive filler has a particle diameter of 10 nm to 100 nm.

4. The metal separator of claim 1, wherein the inorganic polymer is a polymer containing a bond between a Group IVB transition metal element and an oxygen atom.

5. The metal separator of claim 1, wherein the metal substrate is a substrate made of titanium or stainless steel.

6. The metal separator of claim 1, wherein the coating layer has a thickness of 10 nm to 100 nm.

7. The metal separator of claim 1, wherein the coating layer has a contact resistance of 1 mΩ·cm² to 20 mΩ·cm².

8. The metal separator of claim 1, wherein the coating layer has a current density of 0.5 μA/cm² to 30 μA/cm².

9. A method for manufacturing a metal separator, wherein the metal separator comprises a metal substrate; and a coating layer formed on the surface of the metal substrate and including a conductive filler and an inorganic polymer, wherein the conductive filler is included in the coating layer at an area ratio of 5% to 95%, the method comprising:
a first coating step of coating a coating mixture containing a conductive filler and water on the surface of a metal substrate, followed by drying to form a coating layer; and
a second coating step of coating a liquid metal-based organic substance on the dried coating layer, followed by heat treatment to gel the liquid metal-based organic substance into an inorganic polymer.

10. The method of claim 9, wherein the conductive filler is included in the coating mixture in an amount of 0.3 to 5 parts by weight per 100 parts by weight of water.

11. The method of claim 9, wherein the drying is performed at a temperature of 100 °C or more and less than 400 °C under an air atmosphere for 30 seconds to 10 minutes.

12. The method of claim 9, wherein the liquid metal-based organic substance exists in a state in which the metal-based organic substance represented by Chemical Formula 1 below is dispersed in a liquid dispersion medium:
M(OR)₄ [Chemical Formula 1]
wherein M is a Group IVB transition metal element, and R is a straight or branched alkyl group having 1 to 6 carbon atoms.

13. The method of claim 9, wherein the coating of the liquid metal-based organic substance on the dried coating layer is performed by immersing the metal substrate having the dried coating layer formed thereon in the liquid metal-based organic substance, such that the liquid metal-based organic substance is incorporated into the region of the coating layer from which the water has been removed.

14. The method of claim 9, wherein the heat treatment is performed through one or more steps selected from a first heat treatment step performed at a temperature of 100 °C to 380 °C under an air atmosphere; and a second heat treatment step performed at a temperature of 450 °C to 600 °C under a vacuum atmosphere.
